(19) United States
(12) Patent Application Publication
(10) Pub. No.: US 2009/0311579 A1
(43) Pub. Date: Dec. 17, 2009

(54) Power and Hydrogen Generation System

(76) Inventors: Donal F. Day, Baton Rouge, LA (US); Lee R. Madsen, II, Plaquemine, LA (US)

Correspondence Address: PATENT DEPARTMENT;TAYLOR, PORTER, BROOKS & PHILLIPS, L.L.P, P.O. BOX 2471, BATON ROUGE, LA, 70821-2471, US

(21) Appl. No.: 12/373,934

(22) PCT Filed: Jul. 19, 2007
(86) PCT No.: PCT/US07/73860

§ 371 Date: Apr. 7, 2009

Related U.S. Application Data
(60) Provisional application No. 60/832,182, filed on Jul. 20, 2006.

(51) Int. Cl. H01M 6/24; H01M 10/44; H01M 4/02

(52) U.S. Cl. 429/44; 429/105; 429/50

(57) ABSTRACT

A galvanic cell system was discovered that is based on two dissimilar electrodes in an electrolyte solution of hypochlorite and peroxide. The oxidant electrolyte solution contains preferably sodium hypochlorite and hydrogen peroxide in a 10:1 ratio. The cathode (e.g, a copper electrode) was not appreciably consumed. The anode preferably was composed of an aluminum/manganese alloy. This galvanic cell system produced significant current density (e.g., 23 mA/cm²) at a useful voltage (e.g., 1.6-1.7 V/cell). It also produced hydrogen gas, with the maximum production being approximately 1.5 moles of hydrogen per mole of expended anode material. The by-products of this fuel system were environmentally friendly products, including sodium chloride, aluminum hydroxide, and a trace of permanganate ion.

The benefit of the filing date of provisional U.S. application Ser. No. 60/832,182, filed 20 Jul. 2006, is claimed under 35 U.S.C. § 119(e).

### TECHNICAL FIELD

This invention pertains to a new reactive cell which comprises a new system to generate electricity and hydrogen on demand using a combination of a peroxide, an alkali hypochlorite, and a metal anode, preferably of aluminum or an aluminum alloy.

### BACKGROUND ART

New methods for producing electricity are needed for use with batteries, capacitors, fuel cells and similar devices. Additionally, new ways to produce or store hydrogen gas are being sought to improve the inherent safety of hydrogen-powered devices, such as fuel cells. Many of these methods produce waste products that are hazardous. There is a need for a simple, environmentally friendly method to produce hydrogen gas for fuel cells and to produce electricity.

Other galvanic or electrochemical cells have been reported that are based on some combination of aluminum and hydrogen peroxide. See, e.g., D. J. Brodrecht et al., “Aluminum-hydrogen peroxide fuel-cell studies,” Applied Energy, vol. 74, pp. 113-124 (2003); and U.S. Pat. No. 4,369,234. Several systems are based on a two-chambered fuel cell which separates the hydrogen peroxide catholyte from the anolyte solution. See, U.S. Pat. Nos. 5,445,905 and 6,849,356 and U.S. Patent Application Publication Nos. U.S. 2004/0072044 and U.S. 2005/0175878. In addition, sodium hypochlorite has been reported as an effective solution-phase cathode for an aluminum-based seawater battery system. See, M. G. Medeiros et al., “Investigation of a sodium hypochlorite catholyte for an aluminum aqueous battery system,” J. Phys. Chem. B., vol. 102, pp. 9908-9914. Hydrogen peroxide has also been used as a power generator. See, U.S. Pat. No. 6,255,009.

### DISCLOSURE OF INVENTION

We have discovered a galvanic cell system based on two dissimilar electrodes using an electrolyte solution of sodium hypochlorite and hydrogen peroxide. The oxidant electrolyte solution contains sodium hypochlorite and hydrogen peroxide preferably in a 10:1 ratio, as described in U.S. Pat. No. 6,866,870. This oxidant solution is referred to as Ox-B solution. In this system, the cathode (e.g., a copper electrode) was not appreciably consumed. The preferred anode was composed of an aluminum/manganese alloy. This galvanic cell system produced significant current density (e.g., 23 mA/cm²) at a useful voltage (e.g., 1.6-1.7 V/cell). It also produced hydrogen gas, with the maximum production being very close to the theoretical maximum of 1.5 moles of hydrogen per mole of expended anode material. Hydrogen gas was only produced when the device was under load, and production was proportional to the load. The by-products of this fuel system included sodium chloride, aluminum hydroxide, and a trace of permanganate ion. The cathode could be made of several materials, including metals and alloys of copper, nickel, cobalt and tin. Generally, so long as the REDOX potential is greater than Al°/Mn°, the cathode material should work. In addition, a chlorine stabilizer can be used to increase the efficiency of the cell. In the oxidant solution, other alkali metal hypochlorite compounds or mixtures could be used, including sodium hypochlorite, calcium hypochlorite, and lithium hypochlorite.

### BRIEF DESCRIPTION OF DRAWINGS

FIG. 1 illustrates a schematic drawing of one embodiment of a simple system with six cells.

FIG. 2 illustrates the voltage over time from galvanic cells using three different electrolytes: 2.5% Ox-B Solution, 2.5% sodium hypochlorite (NaOCl), and 3.0% hydrogen peroxide (H₂O₂).

FIG. 3 illustrates the current produced as a function of time using a single cell with a copper cathode and an aluminum/manganese anode with 2.5% Ox-B solution, when placed under a 10 Ohm load.

FIG. 4 illustrates the effect on current production of replenishing the Ox-B solution electrolyte as compared to the initial current production in a six-cell system using a copper cathode and an aluminum/manganese anode with 2.5% Ox-B solution and used to drive a small electric motor.

FIG. 5 illustrates the self-cleaning phase in the electrode composed of aluminum/manganese alloy when the electrolyte is 2.5% Ox-B solution.

FIG. 6 illustrates the effect on current production of the galvanic cell system of adding various concentrations of cyanuric acid to the Ox-B electrolyte.

FIG. 7 illustrates the effect on single cell current production, maximum current production, and minimum current production of adding various concentrations of cyanuric acid to the Ox-B electrolyte.

### MODES FOR CARRYING OUT THE INVENTION

The galvanic cell system is based on an electrolyte that is an oxidant solution comprising a mixture of peroxide and hypochlorite. The mixture is formed by adding the peroxide to hypochlorite to form a stable composition, called “Ox-B” solution. The amount of peroxide added to the hypochlorite is preferably sufficient to provide a hypochlorite to peroxide weight ratio of no less than 5:1, with ratios as high as 50:1, 100:1, or higher being possible but less preferred. Most preferably, the weight ratio is about 10:1. This solution is the subject of an issued patent, U.S. Pat. No. 6,866,870, which reports the use of the solution as an effective biocide. For use in this galvanic cell, the preferred solution is a concentration less than 5% hypochlorite: 0.5% peroxide, the more preferred solution is a concentration less than 4% hypochlorite: 0.4% peroxide, and the most preferred solution is a concentration less than or equal to 2.5% hypochlorite: 0.25% peroxide.

The peroxides which may be used in the Ox-B solution may include hydrogen peroxide, alkali and alkali earth metal peroxides as well as other metal peroxides. In addition, percarbonates, (e.g., sodium percarbonate), could be a source of peroxide. Specific non-limiting examples include barium peroxide, lithium peroxide, magnesium peroxide, nickel peroxide, zinc peroxide, potassium peroxide, sodium peroxide, sodium percarbonate, and the like, with hydrogen and sodium peroxide being preferred, hydrogen peroxide being particularly preferred.

The hypochlorites which may be used in the Ox-B solution may include alkali metal hypochlorites such as, e.g., sodium hypochlorite, calcium hypochlorite, lithium hypochlorite, and the like, with sodium hypochlorite preferred. A mixture of alkali hypochlorites can also be used, e.g., sodium hypochlorite and calcium hypochlorite.

The cathode is made of a metal selected from the group consisting of copper, nickel, cobalt, or tin, with the preferred material being copper. The anode is selected from the group IIIa metals or their alloys, such as aluminum, gallium, indium and thallium, with the preferred material being aluminum. The alloys could be made with group VIIb metals, such as manganese and rhenium. The preferred metal alloy for the system is aluminum/manganese alloy.

### EXAMPLE 1

### A Prototype of the Power or Hydrogen Generation System

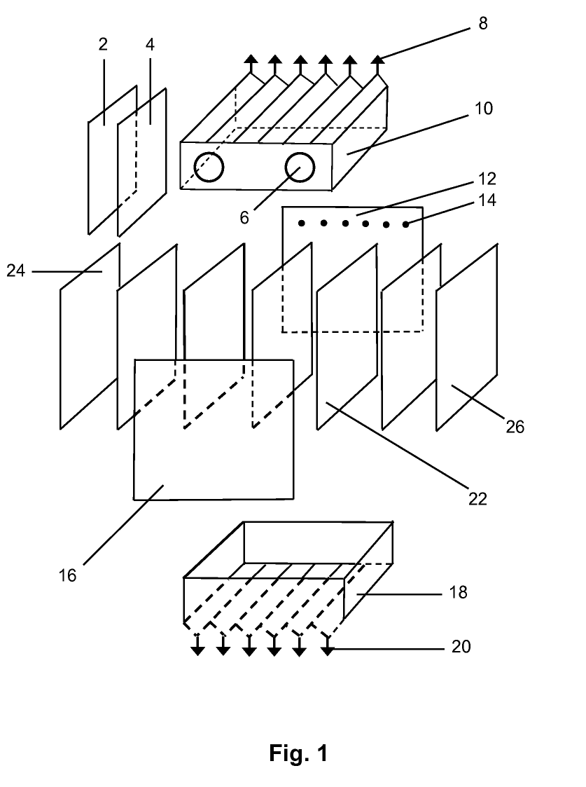

A prototype of six cells similar to the schematic drawing in FIG. 1 was developed, except in the prototype, each cell was separated from the other by a separate glass container. As shown in FIG. 1, the system for use in a fuel cell or battery would have six cells each separated by a cell separator (22). These cells would reside within an enclosure with a top (10), bottom (18), front (16), back (12), left side (24), and a right side (26). Within each cell would be two electrodes, an anode of metal or alloy of aluminum (2) and a cathode, e.g., made of copper (4). Within the overall enclosure, the electrolyte and electrodes are completely separated from the neighboring cell. The back (12) would contain inlet ports (14) leading into each cell to replenish the electrolyte solution. The top (10) would have terminals for an electrical connection (6). The six cells would be wired either in series or in parallel to feel into the electrical connection. Each cell would have one or more gas outlets (8) on the top for hydrogen gas to escape or be captured. Optionally, the top (10) of each cell would have a gas permeable membrane to allow the hydrogen gas to escape, but would not allow fluid into the gas outlet (8) or outside the cell. In the bottom (18), each cell would have a sloping trough to promote efficient waste removal from the outlet ports (20). For example, the aluminum anode will yield aluminum hydroxide hydrate which falls to the bottom, and could be removed from the outlet ports (20).

### EXAMPLE 2

Electrode Consumption During Use in Galvanic Cell System

The electrodes used for the galvanic cell system were the following: (1) The anode was made of either pure aluminum strips, aluminum/manganese alloy strips, or cast aluminum. The case aluminum was made into test “coupons” of 14.5(L)×37 (H)×2.75(W) mm, comprising, on average, surface areas of 13.56 cm². (2) The cathode was made of pure copper either in the form of cut strips or cast-and-milled coupons of matching dimension to those described for the aluminum anode. The immersed surfaces of the anode and cathode for each galvanic cell had comparable surface area. These electrodes were tested in both a single cell and a six-cell configuration.

All coupon tests were conducted using 50 mL of the Ox-B biocide at 2.5% strength, which means 2.5 g sodium hypochlorite and 0.25 g hydrogen peroxide in 100 ml solution. The oxidant solution (“Ox-B”) can be used in concentrations from 1% to 5% sodium hypochlorite, at a ratio of 10:1 hypochlorite: peroxide. For example, a 5% Ox-B solution is equal to 5 g sodium hypochlorite with 0.5 g hydrogen peroxide in 100 ml of solution; while a 2% Ox-B solution is equal to 2 g sodium hypochlorite with 0.2 g hydrogen peroxide in 100 ml water. All chemicals were commercially purchased from Sigma Co. (St. Louis, Mo.), unless otherwise specified.

After use in the galvanic cell system, there was a noticeable difference between the corrosion of the two electrodes. The surface of the anode was corroded, while the cathode surface remained intact. Electrode consumption was monitored from three replicates of a 6 cell system using 2.5% Ox-B solution with an aluminum anode and copper cathode placed under a 10 ohm (Ω) resistive load.

TABLE 1
Electrode Consumption Data (Average of three trials)

| | Average Mass | Average Percent | Average Loss |
|---|---|---|---|
| Electrode | Difference | Loss | %/Min |
| Al/Mn° | 0.155 | 2.113 | 0.0013 |
| Cu | 0.002 | 0.00008 | 0.00001 |

When pure Al was tested as the anode, the amount of electrical current density or the amount of H₂ production was substantially less than that produced with an anode made from the Al/Mn alloy. The alloy coupon material was an alloy of Al°—Mn° with approximately 1-1.5% Mn°, bearing the official designator of #3003. (See http://www.luskmetals.com/chemalum.html) It is believed that the maximum solubility of Mn° in Al° is 1.5%, with the exception of super-cooled amorphous metal alloys; thus alloys made to contain more than this amount of Mn° would be rare, but might be more effective at catalyzing the electrolysis of water.

Anode coupons made of pure Al° resulted in premature consumption of the metal, and in rapid formation of short or dead circuits. In addition, the galvanic cell produced lower peak current densities, and only trivial quantities of H2 gas. Using the same cells, when the experiment was repeated with anode coupons made of Al° /Mn° alloy, the initially observed current densities and H₂ production were maintained until the electrolyte was expended. For the small galvanic cells, a small motor could be driven for about 5 hr before refilling the electrolyte. (Data not shown)

Without wishing to be bound by this theory, it is believed that the success using the Al°/Mn° alloy is the result of concommittant reduction-oxidation reactions between the Mn° and the Al° where the extra electrons are removed from the metal via reduction of the hypochlorite/chlorate complex present in the electrolyte. The Mn° is oxidized by the hypochlorite/chlorate, and then reduced by the aluminum to yield Al²⁺(OH), which is unstable. The Al²⁺(OH) species combines with water (overall, 2H₂O) to yield Al(OH)₃+3/2H₂+3e⁻. This reaction results in significant current densities, and the evolution of 1.5 molar equivalents of H₂ gas. Futhermore, in support of the theory of oxidation of Mn°, as the electrolyte is exhausted, it turns a magenta color, a color assumed to be due to the permanganate ion (MnO₄⁻). This theory is also supported by the fact that Mn° is more easily oxidized than Al°. In addition, since the reduction potential of permanganate is not sufficiently negative to cause further oxidation of the Al° (1.51 V for permanganate vs. −1.676 V for Al°), the permanganate ion will accumulate.

Although the catalytic mechanism is not fully characterized at this time, the following equation is assumed:

MnO₂+Al°+1/2H₂+H₂O+1e⁻←→Mn°+Al(OH)₃

The amount of Mn° present at any time is small relative to the amount of Al°. This results in the reaction as shown above, including several intermediate oxidation states, eg.: Mn° -Mn²⁺, Al°-Al³⁺, etc. Following the above reaction, the Mn is trapped as permanganate, as the galvanic cell began to show signs of exhaustion, and the electrolyte turned pink. When fresh electrolyte (Ox-B) solution was added, the pink color disappeared, and the galvanic cell returned to generating both power and H₂ gas.

It is believed that one exhaustion mechanism for the Ox-B electrolyte involved the reduction of the hypochlorite to yield sodium chloride (NaCl), perhaps by the following reaction:

NaOCl+H₂O₂→NaCl+H₂O+O₂↑

There is also a possibility that sodium chlorate (NaClO₃) may be present in small amounts proportional to the amount of peroxide used. The presence of sodium chlorate may contribute to the persistence of the oxidative potential of the electrolyte as reservoir species.

Ultimately, when the electrolyte was exhausted, the by-products included NaCl, aluminum hydroxide, and a trace (no more than 1.5% mol eq.) of permanganate ion. These products are easy to dispose and thus environmentally friendly. This galvanic cell system results in an environmentally sound instrument for the delivery of hydrogen gas and electricity.

### EXAMPLE 3

### Performance of the Galvanic Cell System

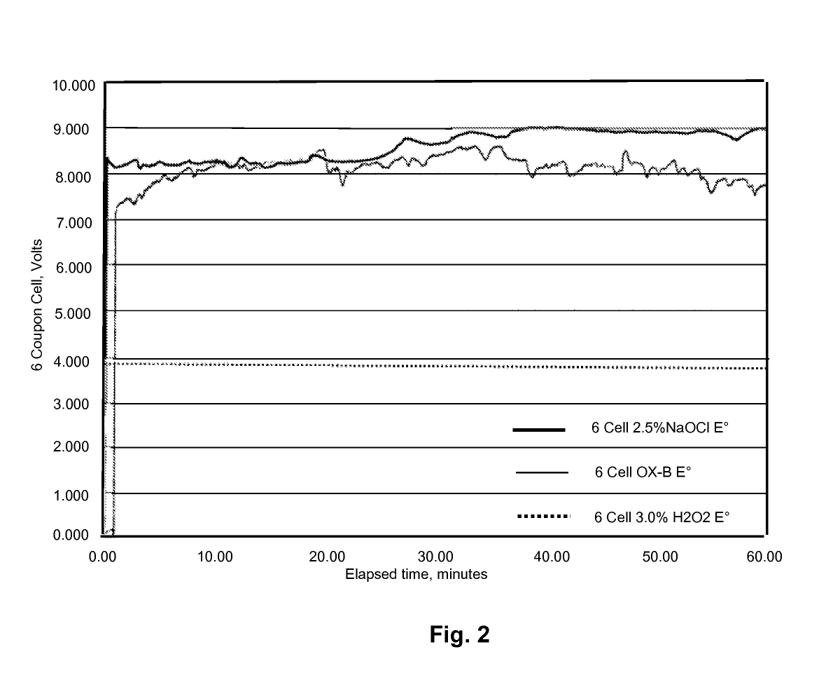

Cells using coupons of Al/Mn and Cu were tested in six-cell systems using three different electrolyte solutions: (1) NaOCl (household bleach) at 2.5%, (2) Ox-B Biocide formulation at 2.5%, and (3) hydrogen peroxide at 3.0%. The open voltage (voltage with only the load from the measuring device) for all three was monitored, and the results are shown in FIG. 2. Voltage was read every 5 sec for 70 min. The spike seen in the H₂O₂ battery at approximately 14 min was the result of a test-clip malfunction. The voltage values were averaged for six runs. The average voltage for the sodium hypochlorite solution was 8.62/6=1.437 V; the average for the Ox-B solution was 7.772/6=1.295 V, and the average for the hydrogen peroxide was only 3.790/6=0.631V. Based on the average, the cell with hypochlorite was the highest. However, when voltage over the entire curve is analyzed, the Ox-B electrolyte was better. In general, the Ox-B gave the greatest current over time with the least destruction in electrode material and/or electrical wiring (or bus). The connections would fail more quickly with NaOCl than with Ox-B, limiting the overall amount of current achievable.

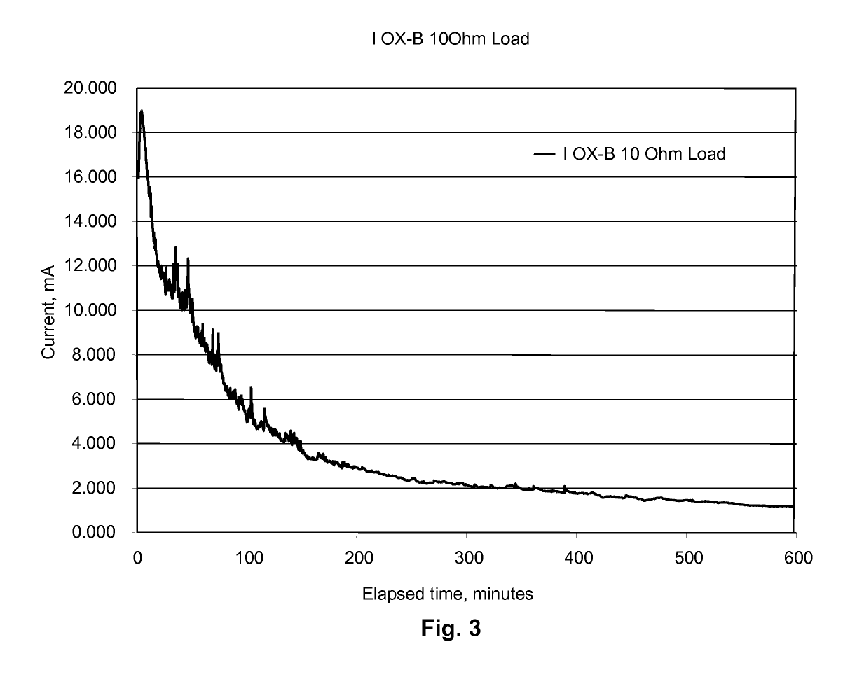

Since it is impossible to measure (with a voltmeter) the voltage without applying some resistance to the circuit, a small load was placed on these cells during testing. The load was proportional to the electrical resistance of the wires used to connect the apparatus to the meter—it was very small, but significant from the cells' point-of-view. FIG. 3 shows the current generated when a 10 Ohm resistive load (⅛ watt resistor) was applied to the six-cell system using 2.5% Ox-B electrolyte. The curve shows substantial noise in the generation of current. The current curves generated using only either hypochlorite or peroxide showed very little noise. (Data not shown) It is believed that the noise in the Ox-B curve was the result of the slow formation of H₂ bubbles on the surface of the electrodes. As bubbles form and detach, the voltage was perturbed, presumably from transient changes in the electrode reactions that are taking place. When the voltmeter and the very small load it represented were connected, negligible bubbling was witnessed relative to the system shorted with a 10 Ω resistive load.

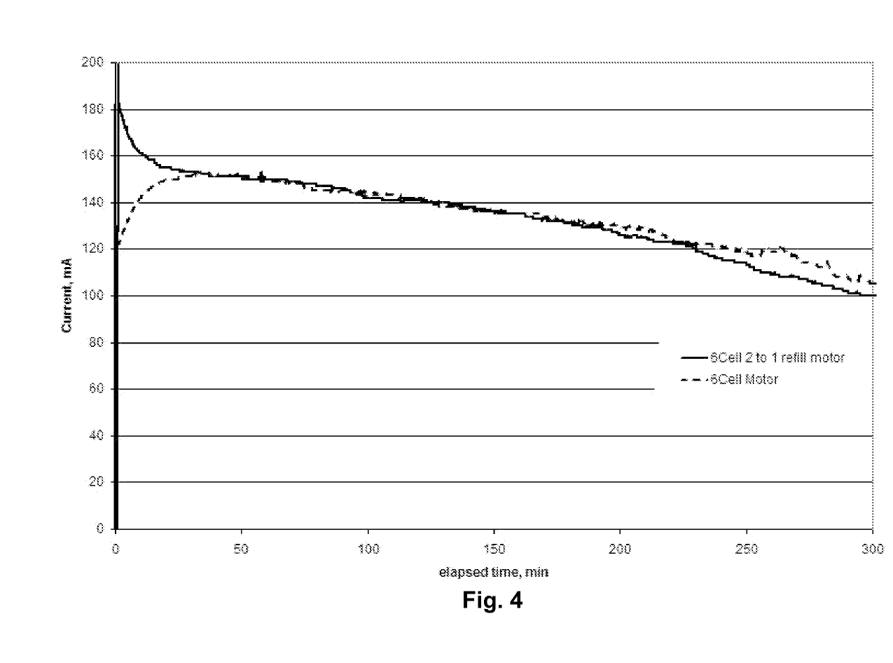

The galvanic cell system using the 2.5% Ox-B electrolyte could be regenerated by adding new electrolyte solution once the current dropped off This cycle may be repeated until electrode and/or bus failure (due to corrosion). FIG. 4 shows the results of current generated by the initial galvanic cell system, and then the effect of replenishing the electrolyte solution. The galvanic cell system in FIG. 4 is a six-cell system with a Cu cathode and Al/Mn anode with 2.5% Ox-B solution, and used to drive a small electric motor. As shown, the current increased and then returned to the initial level by replenishing the electrolyte solution.

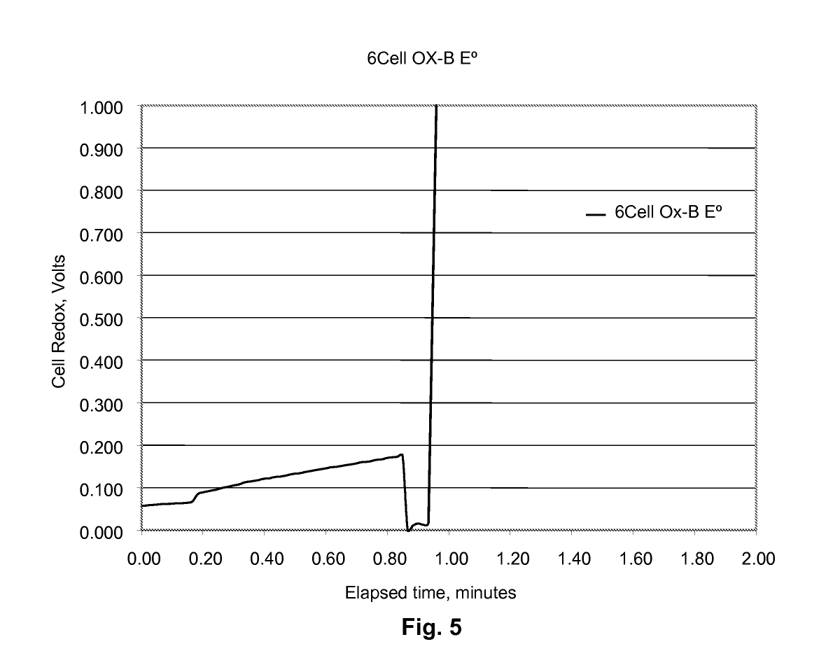

Another feature that was seen exclusively with the Ox-B electrolyte was a “burn-off” phase. This voltage phase occurred when the aluminum anode electrode surface underwent a “self-cleaning” after which the galvanic cell returned to its normal operating voltage. As shown in FIG. 5, this phase occurred within the first 1 min and rapidly disappeared. Without wishing to be bound by this theory, it is believed that the formation of complex oxidation states at the electrode surface removed any protective film on the aluminum anode. FIG. 5 was generated using an Al/Mn anode and a Cu cathode with 2.5% Ox-B electrolyte in a six-cell system.

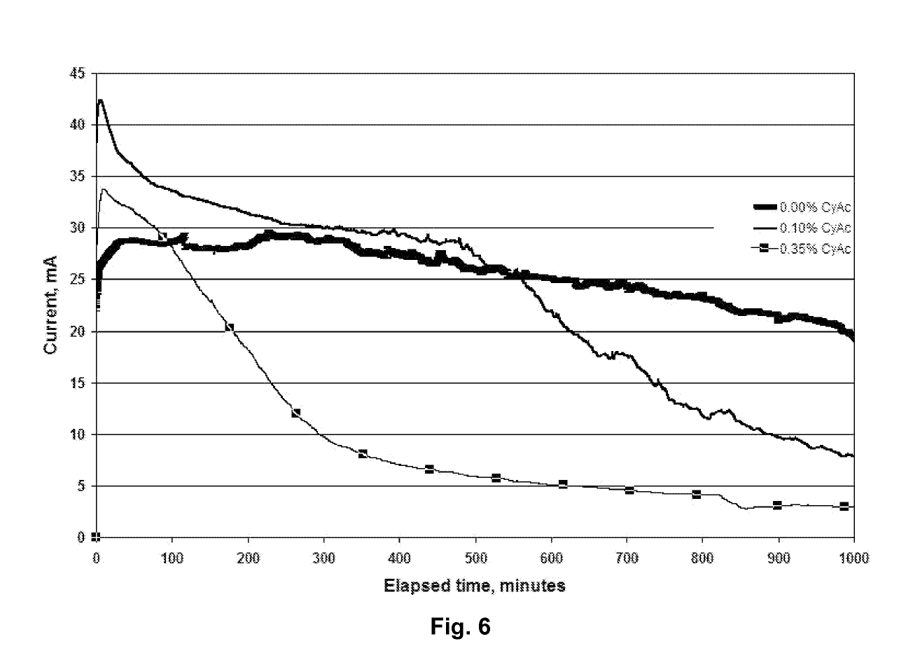

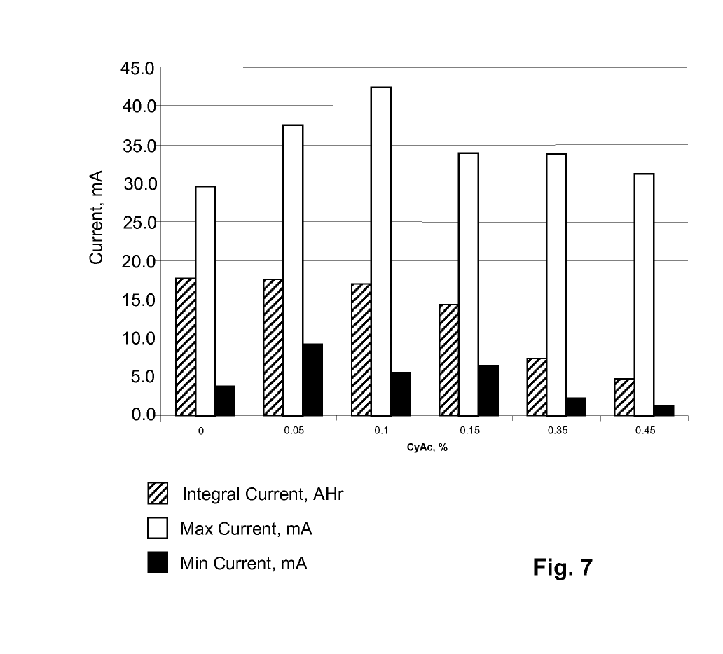

To increase the efficiency of the galvanic cell, an established chlorine stabilizer was used, cyanuric acid (CyAc). CyAc was added to the Ox-B electrolyte solution at several concentrations, from 0.05% to 0.45%. As shown in FIG. 6, addition of 0.05-0.1% CyAc yielded an increase in current (under 10 Ω) for about the first 10 hr. In contrast, higher concentrations of CyAc (0.15%, 0.35%, and 0.45%) caused a decrease in current. FIG. 7 shows the integral current per hour, the maximum current, and minimum current for each concentration of CyAc. The maximum current was produced with the addition of 0.1% CyAc, but this would result in more rapid use of the electrolyte. The integral current was about the same for the cells with 0.05% and 0.1% CyAc as the cell with no CyAc. At concentrations higher than 0.1% CyAc, the efficiency of the cell was decreased in that both lower maximum current and integral current were produced. Although CyAc is the classic stabilizer (used in pool chlorination formulae), other organic compounds or salts might be used, such as potassium dichloroisocyanurate or sodium dichlorocyanurate as anhydrous or dehydrate forms. Additionally, other inorganic compounds might serve as reservoir species, NaClO₃, for example.

We have shown that the use of Al°/Mn° alloy in the presence of the Ox-B electrolyte solution produced useful amounts of both hydrogen gas and electrical current on demand. Further, the byproducts of this process were environmentally benign and recyclable, e.g., reduced back to Al° or table salt (NaCl). In fact, the resulting electrolyte solution would be useful in deicing frozen highways, reducing the amount of salting that is required for safe, ice-free motoring.

Applications of this technology have many potential uses, including, but not limited to, use in energy production and storage devices, and use in production of hydrogen gas. Examples of uses are as components of batteries, capacitors, fuel cells, hybrid battery/fuel cell systems. One advantage as a system for production of hydrogen gas is that hydrogen is generated only on demand when needed, and is not stored under high pressure in a gas tank. Once generated, the hydrogen gas could be used for any application that currently uses hydrogen gas, including but not limited to, internal combustion engines, heating systems, fuel cells, hydrogenation in various chemical processes, jet propulsion, and rocket fuel.

This technology has the advantage of providing hydrogen gas for use without the hazards associated with storage and transport of liquid hydrogen gas. Refueling a device with this galvanic cell system would involve changing the aluminum/manganese electrode and a fresh tank of Ox-B electrolyte. Both of these are very stable and safe.

The complete disclosures of all references cited in this specification are hereby incorporated by reference. In the event of an otherwise irreconcilable conflict, however, the present specification shall control.

1. An electric cell comprising:
(a) An oxidizing electrolyte in aqueous solution, wherein said electrolyte comprises a peroxide and a hypochlorite wherein the so that the weight ratio of the hypochlorite to the peroxide is no less than about 5:1; and
(b) An anode comprising an alloy of aluminum and manganese; and
(c) A cathode.

2. An electric cell as in claim 1, wherein the cathode is selected from the group consisting of copper, nickel, cobalt, or tin.

3. An electric cell as in claim 1, wherein the cathode consists essentially of copper.

4. (canceled)

5. (canceled)

6. (canceled)

7. (canceled)

8. An electric cell as in claim 1, wherein the peroxide is selected from the group consisting of barium peroxide, lithium peroxide, magnesium peroxide, nickel peroxide, zinc peroxide, potassium peroxide, sodium peroxide, sodium percarbonate, and hydrogen peroxide.

9. An electric cell as in claim 1, wherein the peroxide consists essentially of sodium peroxide.

10. An electric cell as in claim 1, wherein the peroxide consists essentially of hydrogen peroxide.

11. An electric cell as in claim 1, wherein the hypochlorite comprises one or more of an alkali metal hypochlorite.

12. An electric cell as in claim 1, wherein the hypochlorite comprises one or more compounds selected from the group consisting of sodium hypochlorite, calcium hypochlorite, or lithium hypochlorite.

13. An electric cell as in claim 1, wherein the hypochlorite consists essentially of sodium hypochlorite.

14. An electric cell as in claim 11, additionally comprising a chlorine stabilizing compound.

15. An electric cell as in claim 14, wherein said chlorine stabilizing compound is selected from the group consisting of cyanuric acid, potassium dichloroisocyanurate, and sodium dichlorocyanurate.

16. An electric cell as in claim 14, wherein said chlorine stabilizing compound is cyanuric acid.

17. An electric cell as in claim 16, wherein the concentration of cyanuric acid is less than or equal to 0.1% weight/volume.

18. An electric cell as in claim 1, wherein the peroxide consists essentially of hydrogen peroxide and the hypochlorite consists essentially of sodium hypochlorite.

19. An electric cell as in claim 18, wherein the weight ratio of the sodium hypochlorite to the hydrogen peroxide is about 10:1.

20. An electric cell as in claim 1, wherein said electrolyte is formed by adding the peroxide to the hypochlorite.

21. A method of producing hydrogen gas comprising the steps of:
(a) Providing the electric cell of claim 1, wherein said anode and said cathode are placed in the electrolyte; and
(b) Placing an electrically resistive or inductive load between said anode and cathode.

22. A battery comprising the electric cell of claim 1.

23. A fuel cell comprising electric cell of claim 1.
